(19) United States
(12) Patent Application Publication
(10) Pub. No.: US 2010/0262625 A1
(43) Pub. Date: Oct. 14, 2010

(54) METHOD AND SYSTEM FOR FINE-GRANULARITY ACCESS CONTROL FOR DATABASE ENTITIES

(76) Inventor: Glenn Robert Pittenger, Seattle, WA (US)

Correspondence Address: OLYMPIC PATENT WORKS PLLC, P.O. BOX 4277, SEATTLE, WA, 98104, US

(21) Appl. No.: 12/618,496

(22) Filed: Nov. 13, 2009

Related U.S. Application Data
(60) Provisional application No. 61/212,199, filed on Apr. 8, 2009.

(51) Int. Cl. G06F 17/30

(52) U.S. Cl. 707/783; 707/E17.005; 707/781

(57) ABSTRACT

Method and system embodiments of the present invention are directed to providing fine-granularity access control to data entities within databases. Certain method and system embodiments of the present invention are directed to providing row-and-column-level access control to relational tables, relational views, and other database entities managed by relational database management systems. Certain embodiments of the present invention employ additional database tables, user-defined functions, and automatically created security views to create and maintain a view-based interface to an underlying database through which users access data stored in the underlying database. The view interface includes automated access control features that provide row-and-column access controls to users of the database management system.

### CROSS-REFERENCE TO RELATED APPLICATION

This application claims the benefit of Provisional Application No. 61/212,199, filed Apr. 8, 2009.

### TECHNICAL FIELD

The present invention is related to database management systems and, in particular, to a method and system for providing fine-granularity access control for database entities within databases.

### BACKGROUND OF THE INVENTION

Electronic databases represent an important and enormous field within computer science. Electronic databases underlie many of the computer-based technologies and services that, in turn, underlie large portions of commerce, education, research and development, and other social activities.

There are many different types of electronic databases. In general, databases are computer files and information stored in memory within computer systems. The data is managed, and access is provided to the data, through interfaces provided by a database management system, generally one or more complex computer programs that execute on one or more computer systems. Often, the electronic database is a component of various different types of business applications, service applications, and other types of specialized computer programs and systems. As one example, an accounting and personnel-management system, used by the financial and personnel departments of a small company, may be implemented as a collection of computer programs and routines that execute on computers of a centralized computing facility within the company and that access data managed by a database management system. In such systems there are many different hierarchical levels of understanding and knowledge of the data, stored in electronic computer files and managed by the database management system. The data may be organized according to a database schema developed by a database administrator. The data and database schema may be created and manipulated by various application programs that access the database management system through well-known database-management-system interfaces.

Often, database administrators, database developers, and developers of application programs that interface with database-management systems (“DBMSs”) seek to provide, to different users, various levels, of access to data within database tables. Many current relational-database-management systems (“RDBMSs”) provide table-level access control to allow groups of users access to all or a subset of the tables defined within a particular database. Database administrators, database developers, developers of application programs that interface with database-management systems, and, ultimately, users of database management systems continue to seek new and improved techniques and systems for efficiently providing new and improved types of access control for data entities managed by various types of DBMSs.

### SUMMARY OF THE INVENTION

Method and system embodiments of the present invention are directed to providing fine-granularity-access control to data entities within databases. Certain method and system embodiments of the present invention are directed to providing row-and-column-level access control to relational tables, relational views, and other database entities managed by relational database management systems. Certain embodiments of the present invention employ additional database tables, user-defined functions, and automatically created security views to create and maintain a view-based interface to an underlying database through which users access data stored in the underlying database. The view interface includes automated access control features that provide row-and-column access controls to users of the database management system.

### BRIEF DESCRIPTION OF THE DRAWINGS

FIGS. 1-2 illustrate the basic data entity created and stored in a relational database management system.

FIGS. 3A-D show entity-relationship-diagram representations of tables shown in FIGS. 1 and 2 and illustrate aspects of one entity-relationship diagramming method commonly employed to illustrate relationships, logic, and understanding of data within a relational database.

FIGS. 4A-C illustrate aspects of one entity-relationship diagramming method commonly employed to illustrate relationships, logic, and understanding of data within a relational database.

FIG. 5 illustrates an exemplary computational environment in which method and system embodiments of the present invention are employed.

FIGS. 6A-C illustrate various compressed and truncated versions of the Employees table shown in FIG. 1.

FIG. 7 illustrates a general approach to providing access control used by certain method and system embodiments of the present invention.

FIG. 8 illustrates, using a control-flow diagram, the general approach of certain method and system embodiments of the present invention to providing ongoing row-and-column-level access to tables and views of one or more databases.

FIG. 9 shows a schema, using the entity-relationship diagramming method discussed above with reference to FIGS. 3A-D and 4A-C, for the access-control database created in step 802 of FIG. 8 by one embodiment of the present invention.

FIG. 10 provides an example extract from an XML file that provides metadata that is processed in step 807 of FIG. 8, according to one embodiment of the present invention.

FIG. 11 provides a create-view command that creates a security view for a particular underlying database table through which users access the underlying database table, according to one embodiment of the present invention.

FIGS. 12A-E provide and exemplary auto-gen program.

### DETAILED DESCRIPTION OF THE INVENTION

Certain method and system embodiments of the present invention are directed to providing row-and-column-level access control to tables of a relational database. Methods of the present invention are, with certain adaptations, potentially applicable to other types of database management systems in which data entities are stored according to paradigms other than tables. Because relational databases represent a large fraction of currently-used databases, the following discussion provides details of those embodiments of the present invention directed to relational databases.

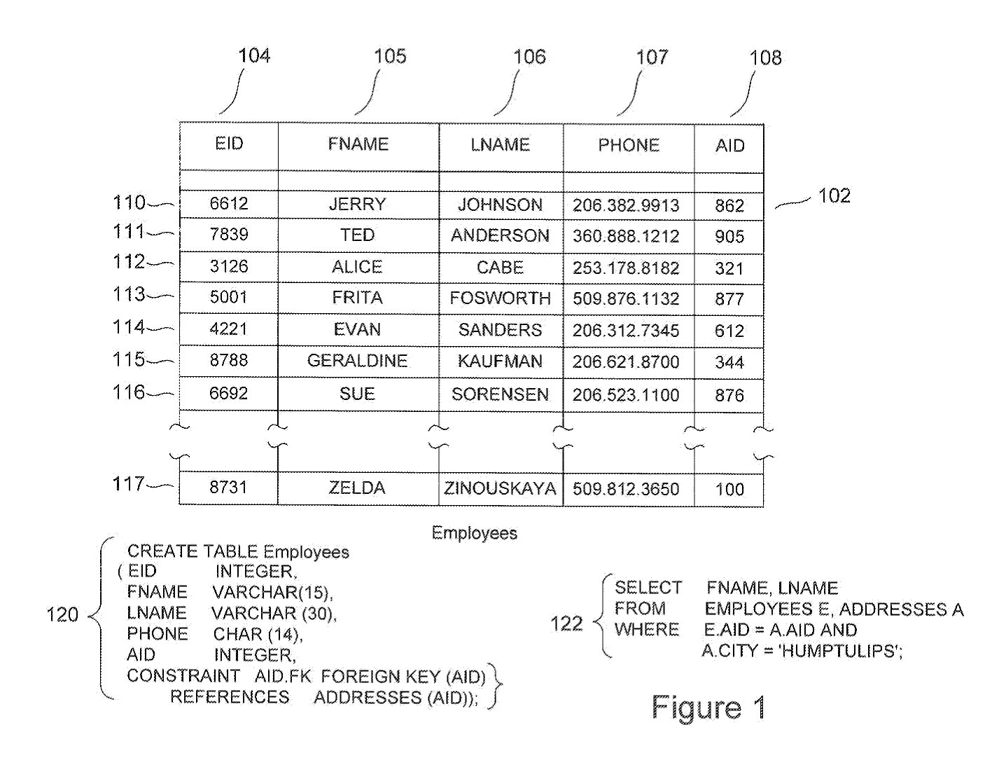

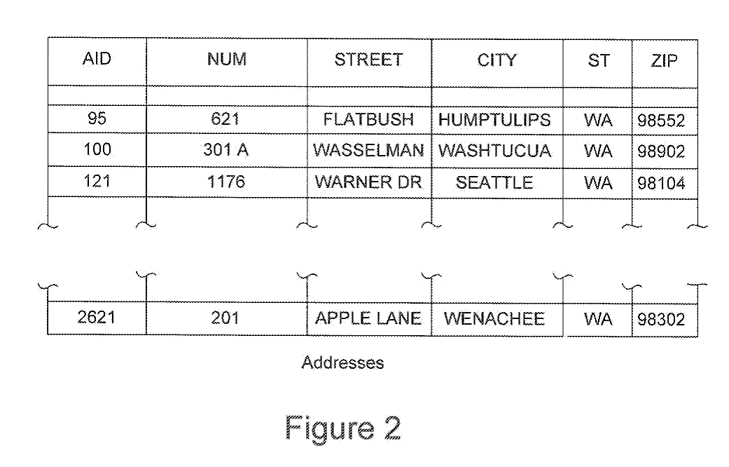

FIGS. 1-2 illustrate the basic data entity created and stored in a relational database management system. FIG. 1 shows a relational database table, named “Employees” 102, which contains data descriptions of the employees within an organization. The table includes five columns 104-108 and a potentially large number of rows, including rows 110-117. Each row in a relational database table represents an instance of a type of real or abstract object. In the case shown in FIG. 1, each row in the Employees table represents an employee of an organization. The columns correspond to attributes that characterize each instance. In the Employees table shown in FIG. 1, each employee is characterized by an employee identification number contained in column “EID” 104, a first name contained in column “FNAME” 105, a last name contained in column “LNAME” 106, a phone number contained in column “PHONE”107, and an address identifier contained in column “AID”108. The address-identifier attribute refers to a particular address in an Addresses table, shown in FIG. 2. The Employees table is created, by a structured query language (“SQL”) create-table statement 120, and information can be extracted from this table, and the Addresses table shown in FIG. 2, by the exemplary SQL select command 122 shown in FIG. 1. In this case, the select command provides a derived, temporary table including columns for the first and last name of employees and row that describe all employees who live in the town of “Humptulips.” Note that a constraint clause 124 at the end of the create-table command 120 indicates that an entry in the AID column of the employees table references an entry in the Addresses table, shown in FIG. 2, through the AID column of the Addresses table. Such constraints are enforced, during updates of tables, by a relational database management system. In the Employees table, the employee identifier ID serves as a unique identifier, or key, for each Employee-table entry.

A view, in certain relational database systems, is an abstract window into the data within an underlying table, created by an SQL create-view command. The view does not actually store data, but acts as a filter, providing to a user, who accesses data through the view, only those columns and rows of the underlying table that are included in the view by the create-view command. The word “view” is used in the sense of the bounded view of the outside world obtained by looking through a window or a view of a portion of a larger object observed through a magnifying glass.

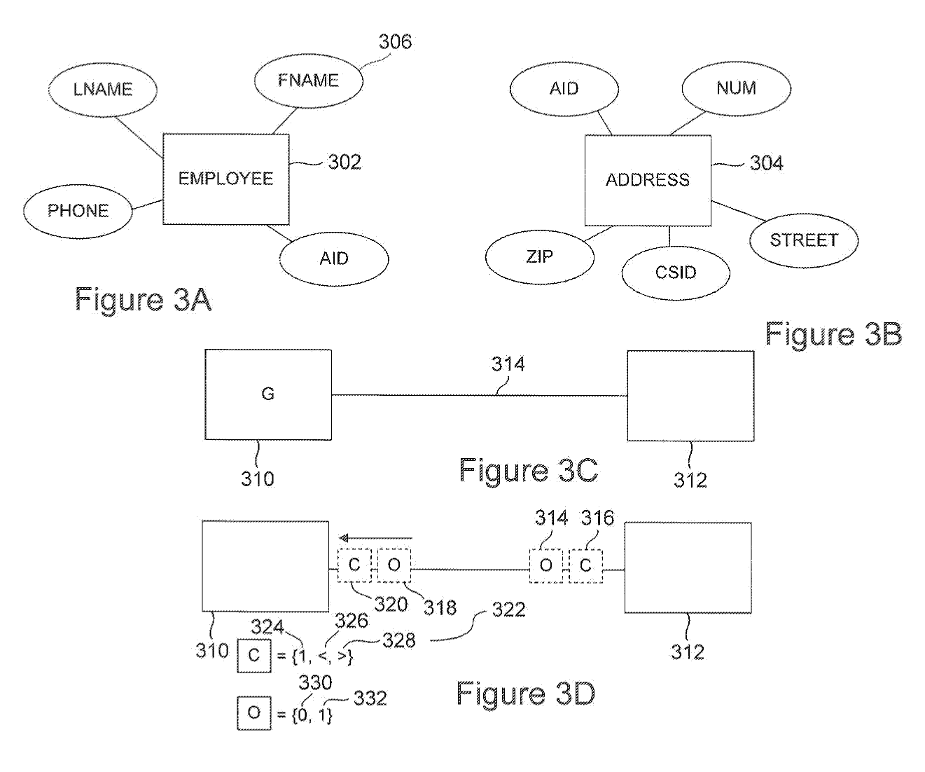

There are many different ways to represent relationships between data entities in a database. One popular method is to use entity relationship diagrams. FIGS. 3A-D show entity-relationship-diagram representations of tables shown in FIGS. 1 and 2 and illustrate aspects of one entity-relationship diagramming method commonly employed to illustrate relationships; logic, and understanding of data within a relational database. Each table in a relational database is an entity, and entities are modeled as rectangles containing the name of an entity, such as rectangles 302 and 304 in FIGS. 3A-B that represent the “Employees” table (202 in FIG. 2) and the “Addresses” table (204 in FIG. 2). Attributes of the table are shown as ellipses containing the name of the attributes connected to the entity. For example, the attribute “FNAME” of the table “Employees” (202 in FIG. 2) is represented by ellipse 306 in FIG. 3A.

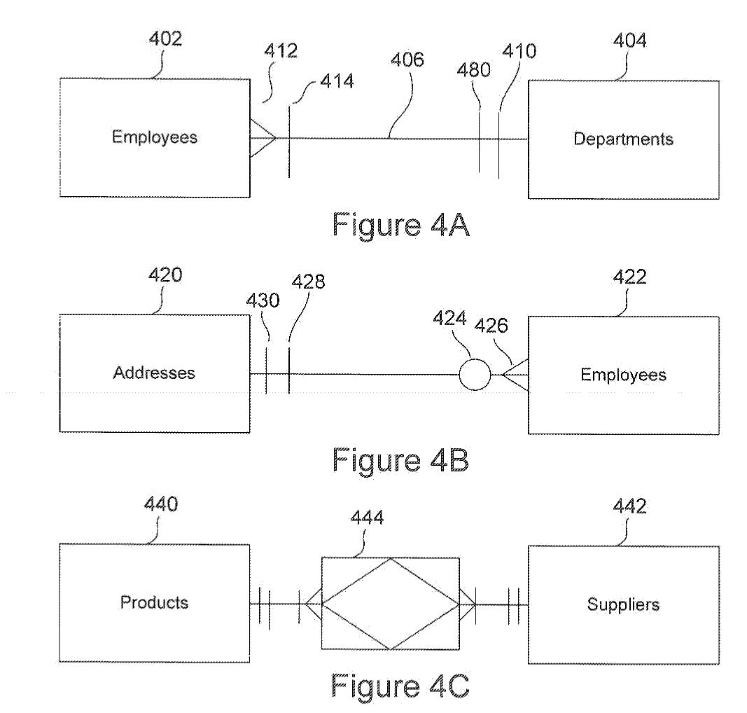

Relationships between tables are shown by lines in entity relationship diagrams. For example, in FIG. 3C, a relationship between a first table 310 and a second table 312 is shown by line 314. The lines are generally annotated. FIG. 3D describes the annotation conventions. The type of relationship represented by the line from the first entity 310 to the second entity 312 is described by two graphical symbols 314 and 316, and the relationship between the second entity 312 and the first entity is described by two graphical symbols 318 and 320. The symbols 316 and 320 are cardinality symbols. A cardinality symbol may be one of the three symbols 322 shown within brackets in FIG. 3D. The first of these symbols 324 indicates that the relationship is one-to-one, and the second two symbols 326 and 328 are used to describe one-to-many and many-to-one relationships. Symbols 314 and 318 are optionality symbols, indicating whether or not a relationship is optional, represented by symbol 330, or required, represented by symbol 332. FIGS. 4A-C illustrate aspects of one entity-relationship diagramming method commonly employed to illustrate relationships, logic, and understanding of data within a relational database. In FIG. 4A, an employee entity, or table, 402 is related to a department table 404 by relationship 406. Because each employee must be a member of a department, and only one department, annotation symbols 408 and 410 are employed, and because a department may contain multiple employees, but each department must have at least one employee, annotation symbols 412 and 414 are used. FIG. 4B illustrates a relationship between an address table 420 and an employee table 422. Annotation symbols 424 and 426 indicate that an address may or may not be associated with an employee and that any particular address may be associated with multiple employees, while annotation symbols 428 and 430 indicate that each employee is associated with a single address. In FIG. 4C, a many-to-many relationship between a product table 440 and a supplier table 442 is shown.

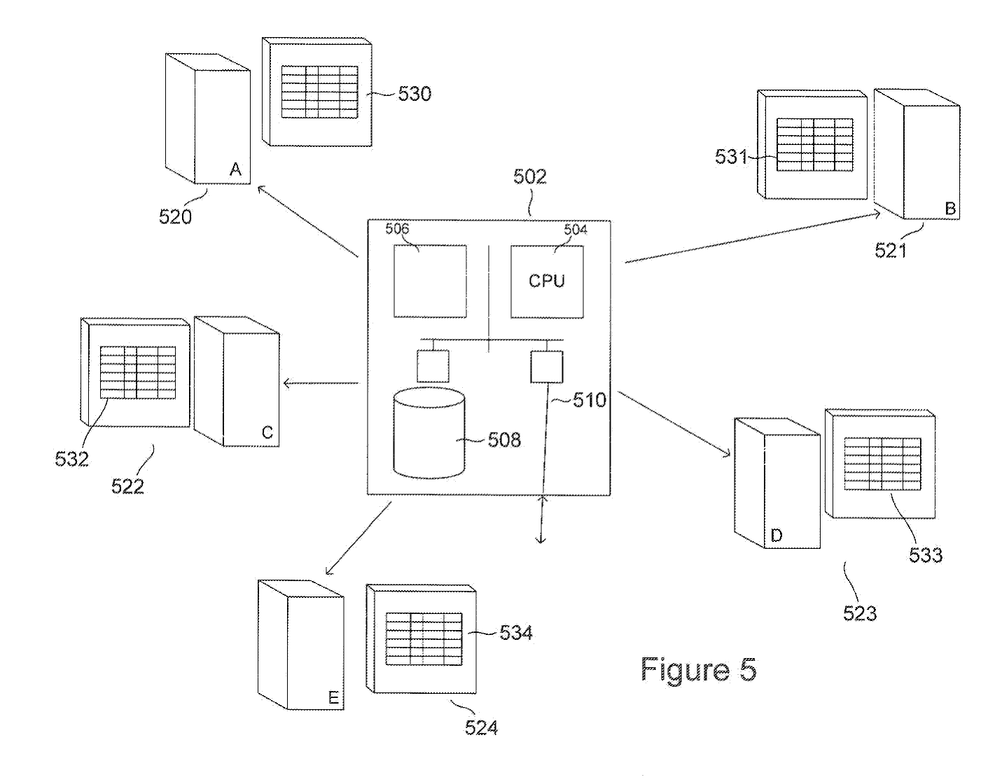

FIG. 5 illustrates an exemplary computational environment in which method and system embodiments of the present invention are employed. In FIG. 5, a database management system executes, on one or more computer systems 502, each including one or more processors 504, electronic memory 506, and internal and external mass-storage devices, including internal mass-storage device 508. In addition, computer systems generally provide one or more communications subsystems 510 to allow data to be input from, and output to, remote computer systems. In FIG. 5, five personal-computer systems or work stations 520-524, are used by, for example, five employees A, B, C, D, and E in an organization, to directly access, or run application programs that access, relational data managed by the relational database management system that runs within computer system 502. Continuing with the example of FIGS. 1 and 2, the five different employees may access, concurrently or at different times, the Employees table discussed above with reference to FIG. 1. The Employees table may be displayed to the users through a relational database interface 530-534, as shown in FIG. 5, or may be accessed by application routines that use data extracted from the table for various purposes.

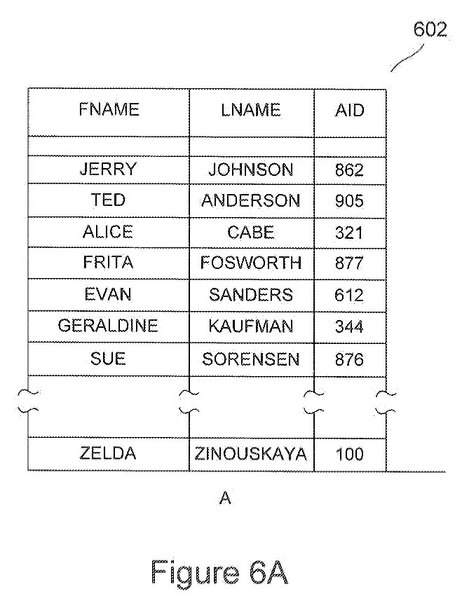

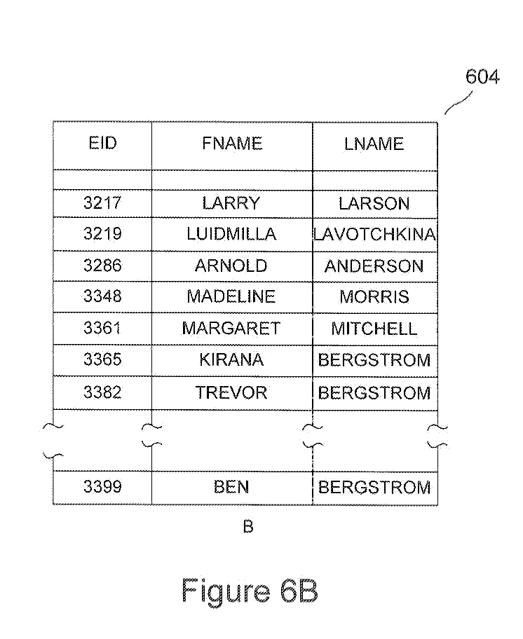

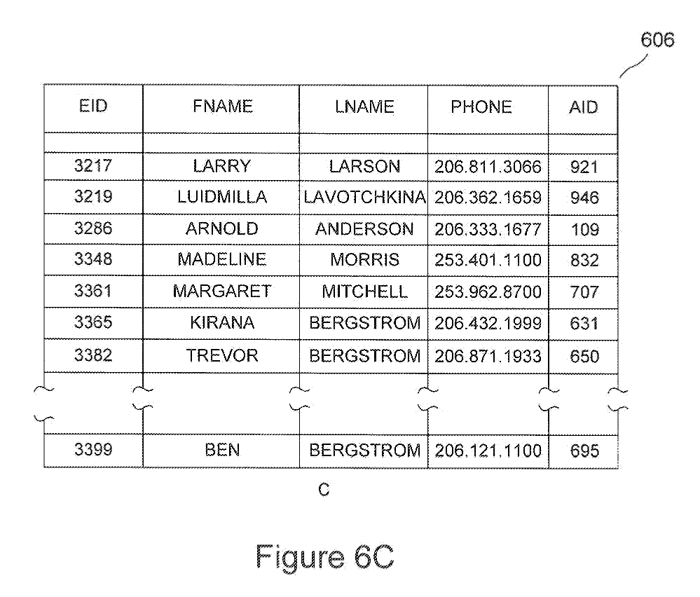

It may be the case, in the example shown in FIG. 5, that certain of the employees should not be able to access all of the data in the Employees table. FIGS. 6A-C illustrate various compressed and truncated versions of the Employees table shown in FIG. 1. FIG. 6A shows that portion of the data in the Employees table that a system administrator may wish Employee A to access. Employee may need only to be able to identify employees of the organization by name and access their addresses in order to send correspondence to the employees. Thus, a database administrator may wish to provide Employee A only with access to the FNAME, LNAME, and EID columns of the Employees table, as shown in the compressed table 602 in FIG. 6A. This represents an example of column restriction, or column access control. Employee B may need to access, at most, a limited number of columns of the Employees table, but only for a subset of rows. For example, employee B may need access only to rows represents, employees of a certain department. The department associated with employees may be found from another table that references the EID value for employees in the Employees table. It may be the case that the department for which Employee 13 works has assigned EID numbers to employees of the department that range from 3200 to 3399. Thus, the compressed and truncated version of the Employees table 604, shown in, FIG. 6B, represents that, portion of the Employees table that a database administrator may wish Employee B to have access to. The compressed and truncated version of the Employees table 604 is compressed to include only three columns of the underlying Employees table and is truncated to include only those rows with EID numbers ranging from 3200 to 3399. This table represents row-and-column access control. Similarly, a database administrator may allow a personal manager for the department to have access to all of the columns of the Employees table, but to only those rows representing employees in that department, as represented by the truncated table 606 shown in FIG. 6C.

Certain method and system embodiments of the present invention are directed to providing the types of row-and-column-level access control for database tables, and other data entities within databases, such as, the row-and-column-level access control illustrated in the example of FIGS. 5-6C. Certain currently available databases provide access control for tables, but this granularity is generally insufficient in many applications, such as the one discussed above with reference to FIGS. 6A-C. Database administrators, database developers, and application-program developers often wish to have the ability to restrict access to, or provide access to, individual rows and columns of relational database tables. Such row-and-column-level access control might be provided in various different ways. Hypothetically, row-and-column-level access control features might be built into a relational database management system, at one extreme, or a database administrator might attempt to provide such fine-granularity access control by creating and maintaining a separate view of each relational database table for each potential user, at another extreme. The first approach involves addition of new interfaces and features to a relational database management system, and would likely require large amounts of existing application programs and database configurations to be rewritten, retested, and debugged. A database administrator of application developer would, in addition, need to wait for these features to become available. The latter approach would involve an enormous amount of work on the part of a database administrator, and would be difficult to update and maintain in view of the natural evolution of a database, users of a database, and database applications over time.

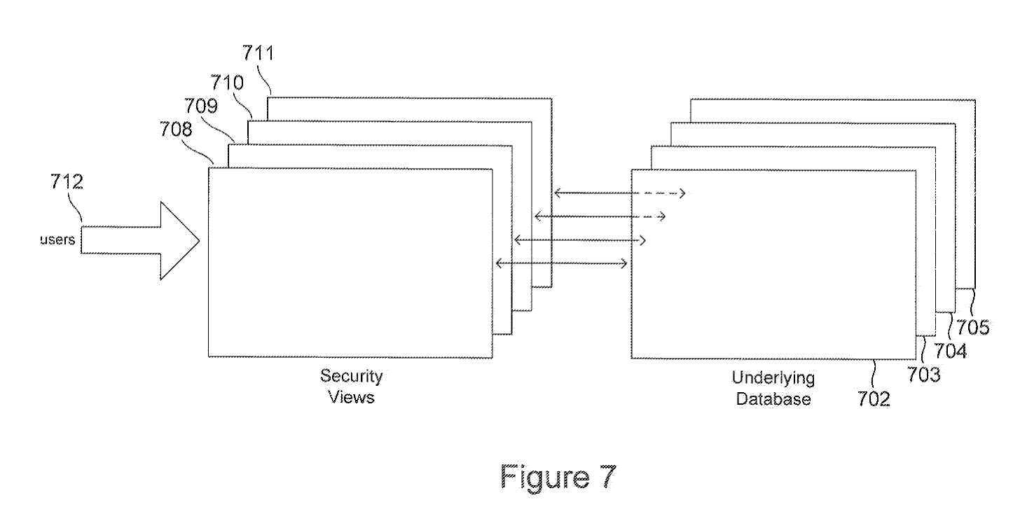

One embodiment of the present invention takes a markedly different approach than the hypothetical approaches discussed above. FIG. 7 illustrates a general approach to providing access control used by certain method and system embodiments of the present invention. In FIG. 7, rectangles 702-705 represent tables of an underlying database, or views of tables of the underlying database, to which a database administrator wishes to apply row-and-column-level access control in order to restrict access by particular users or sets of users to particular columns and rows. Certain method and system embodiments of the present invention create, for each underlying database entity, including tables and views 702-705, an associated security view 708-711. The set of security views 708-711 represents a view interface through which users, and application programs access 712 the underlying database tables and views 702-705, rather than accessing the underlying tables directly through a database interface.

In certain relational database systems, a view can be defined, in part, using user-defined functions (“UDFs”), which are executed at nm time when the view is accessed. The security views created by certain method and system embodiment's of the present invention, provide a run-time filter that filters the data stored within underlying database tables and views 702-705 on behalf of accessing users, at run time, using. UDFs, so that the users see only portions of the underlying tables for which they have permission to access.

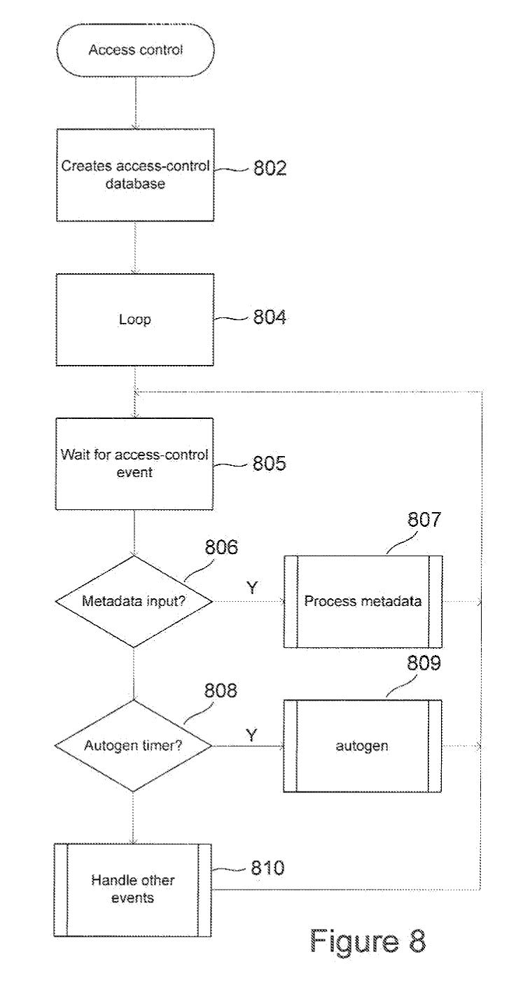

FIG. 8 illustrates, using a control-flow diagram, the general approach of certain method and system embodiments of the present invention to providing ongoing row-and-column-level access to tables and views of one or more databases. In a first step 802, an access-control database comprising, in the currently-described embodiment of the present invention, 12 relational database tables that may be stored in a separate database or within a database to which row-and-column-level access control is provided. These tables, discussed below, provide information needed to create the security views for each underlying table and view of a database or databases to which row-and-column-level access control is provided by the method and system embodiments of the present invention. Next, in a loop comprising steps 804-810, access control is defined and provided to users of one or more databases on a continuing basis. In essence, the method and system embodiments of the present invention wait for certain access-control-related events to occur; and handle those events. One event is input of metadata, in the form of interactive data input by a database administrator, extensible markup language (“XML”) files or other structured-data files that contain the metadata, and by other means. When metadata is input, as detected in step 806, a process-metadata routine is called, in step 807, to extract the data from the file, user-interface, or other input means and enter the extracted data into the database tables that together comprise the access-control database, created in step 802. Another event is expiration of an autogen timer, or detection that the next time for execution of an auto-gen program has arrived, as determined in step 808, in which case an autogen program, discussed below, is called in step 809. Any other events are handled by a default event handler in step 810. Such events might include, for example, various reporting events, disabling of the access-control system, various types of error handling that may be necessary, and other such types of events.

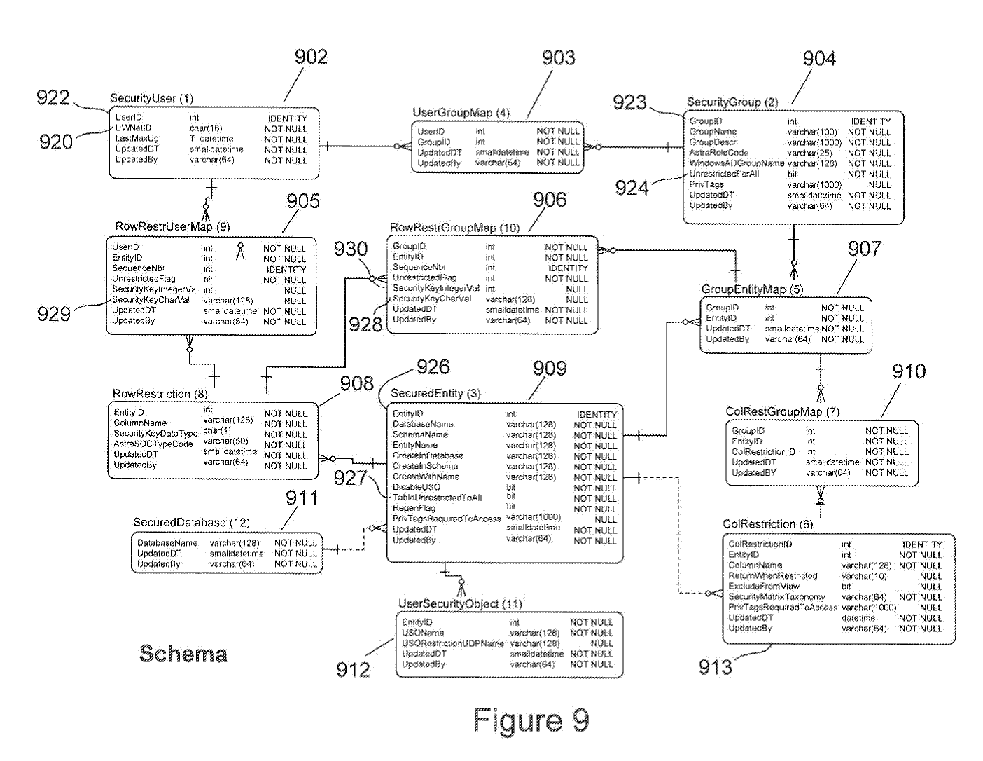

FIG. 9 shows a schema, using the entity-relationship diagramming method discussed above with reference to FIGS. 3A-D and 4A-C, for the access-control database created in step 802 of FIG. 8 by one embodiment of the present invention. The access-control database comprises 12 relational tables 902-913. In FIG. 9, the names and data types of the columns of each table are shown within the rectangles representing each table. The SecurityUser table 902 includes entries that identify each of the users to which access control is provided. In one embodiment of the present invention, a user's login name 920 is a natural key, from which a surrogate key, UserID 922, is derived. The SecurityGroup table 904 identifies all of the various groups, or roles, to which users may belong, that are provided group access rights to columns and rows of the underlying tables and views of one or more databases. A key for the SecurityGroup table is the GroupID column 923. Attributes of each row in the SecurityGroup include a name, text description of the group, a bit that indicates, when set, that users of the group have full access to all of the data entities 924, and additional information, concerning who last updated the table and when the table was last updated, information included in many of the other tables of the access control database. The UserGroupMap table 903 essentially provides a many-to-many mapping between users and groups, so that users may belong to one or more groups. The SecuredEntity table 909, with primary key “EntityID” 926, includes an entry for every table and view in an underlying database or databases to which access control is applied by certain method and system embodiments of the present invention. Attributes include the name of the table, the name of the database in which the table is included, the name of the schema in which the table is defined, a bit to provide unrestricted access to the table 927, and other information. The GroupEntityMap table 907 provides a many-to-many mapping between security entities and groups, with each mapping representing a column restriction or row-access permission for a particular group with respect to a particular underlying table. The ColRestriction table 913 includes column restrictions, each column restriction applied to a particular column of a particular table, and includes an indication of column values that are displayed to users without access to the column. In other words, unlike the example of FIGS. 6A-C, in the described embodiment of the present invention, a user sees all of the columns of an underlying table or view, but, within restricted columns, sees NULL values or some other value, rather than the values contained in the column in the underlying database table or view. The ColRestrGroupMap table represents a many-to-many relationship between groups and column restrictions. Row restrictions are represented by entries in the RowRestriction table 908. Each entry in the RowRestriction table defines a column, within an underlying database table, the values contained in which provide a basis for row restriction. When a group or user has a particular character-based security key, defined by the attribute SecurityKeyCharVal 928 in the RowRestrGroupMap 906 for groups, or by the attribute SecurityKeyCharVal 929 in the RowRestrUserMap 905 for users, and when the column on which row-level restriction is defined for a particular table has rows with that value, a member of the group or user can access those row of that table. Security keys are also provided, in both tables, for integer-based column values. The RowRestrGroupMap table defines security key values for rows of a particular table and for a particular group. The keys, including a character-based key 928 and integer-based security key 930, provide access to particular rows, with the character-based key used for row-access columns with character data types and the integer-based security key used for row-access columns with integer data types. The RowRestrUserMap table 905, in similar fashion, provides row access on a per-user basis. The SecureDatabase table 911 contains entries for all the databases that are provided access control by a method or system embodiment of the present invention that creates and uses the access-control database shown in FIG. 9. The UserSecurityObject table 912 contains rows that each describes a view created as part of the view interface, described above with reference to FIG. 7.

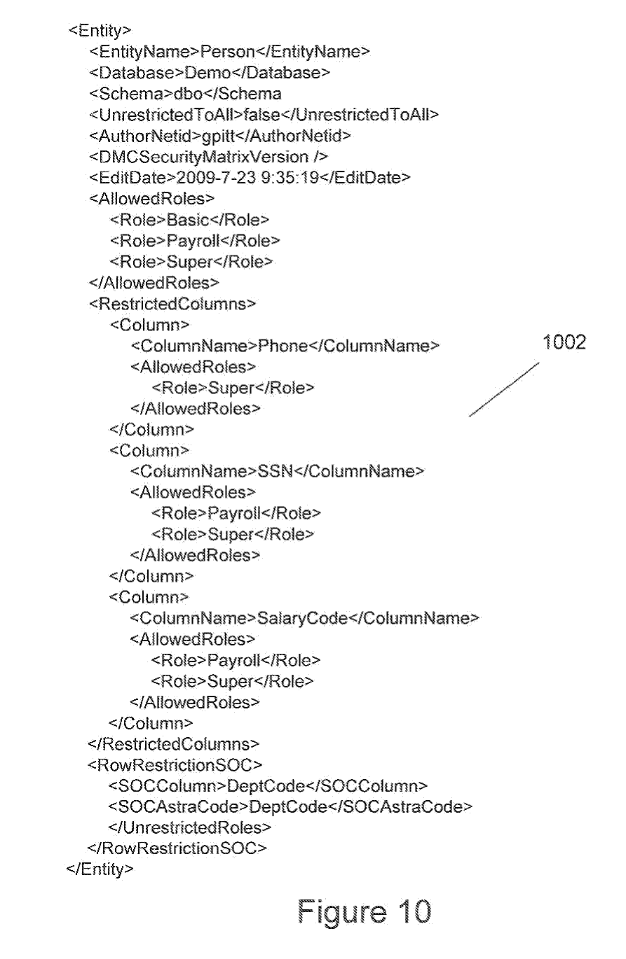

FIG. 10 provides an example extract from an XML file that provides metadata that is processed in step 807 of FIG. 8, according to one embodiment of the present invention. This includes a list of roles, or groups, to be associated with the table, a list of restricted columns and indications of the groups which have access to those columns, and definition of row restrictions based on a “DeptCode” column of the table to which application control is specified in the extract. This is a simple example of definition of one type of metadata that may be included in an XML metadata file input to a system embodiment of the present invention. Metadata included in the XML file may generate many different types of data that is stored, by the metadata-process routine, within the 12 database tables that represent the access-control database, discussed above with reference to FIG. 9. Thus, users can be added, row permissions for particular users can be added, tables to which access control is provided can be designated, roles, or groups, can be defined, and all other types of configuration for access control can be defined using appropriate metadata encoded within an XML file. Alternatively, a user interface can be provided, to particular authorized users, such as database administrators, to directly input entries into the various access-control database tables.

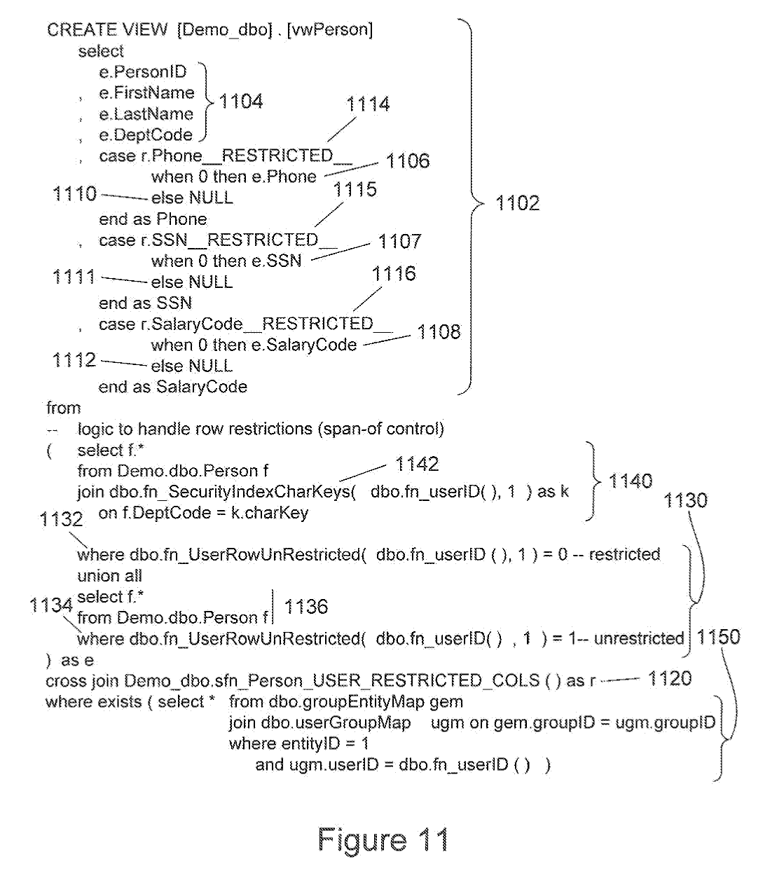

FIG. 11 provides a create-view command that creates a security view for a particular underlying database table through which users access the underlying database table, according to one embodiment of the present invention. The create-view command is generated and executed by the autogen program, called in step 808. In general, metadata can be added to the access-control database, described above with reference to FIG. 9, at any point in time, but takes effect only when the autogen program is executed to generate new views for all of the underlying tables of the database affected by updates to the metadata contained in the access-control database since the last execution of the autogen program. As discussed above, the security view is a runtime filter that returns data to an accessing user according to the row permissions and column restrictions relevant to the user. In a first part of the create-view command 1102, the columns for the security view are defined. Values for unrestricted columns are imported directly from the underlying table in code section 1104. Values for restricted columns are either imported from the underlying table, on lines 1106-1108, when the user is provided access to those restricted columns by the fact that there is no column restriction, with respect to the underlying table or view, associated with a group to which the user belongs, or null values are entered for the column, on lines 1110-1112, when the column is restricted to all groups to which the user belongs. The values displayed for restricted columns is defined in the ColRestriction table (913 in FIG. 9), and these values are entered into the create-view commands generated for each underlying table or view by the autogen program. In the current example, shown in FIG. 11, the values displayed for restricted columns is, in all cases, NULL. Whether or not data for an underlying column of an underlying table is provided in a column of the security view is controlled, in the example shown in FIG. 11, by the value of the columns “r.Phone_RESTRICTED_” 1114, “r.SSN_RESTRICTED_” 1115 and “r.SalaryCode_RESTRICTED_” 1116 in the single row of table “r” that is generated by a tabular UDF 1120. The UDF called in line 1120 of the create-view command generates a one-row table with a column for each restricted column in the underlying database table, having entries “0” or “1” indicating whether or not the column is restricted. This UDF is a run-time routine that obtains the user ID identifier for a user and uses the user identifier to access groups to which the user belongs in the access-control database in order to determine whether or not the user belongs to any group that is not mapped through an entry in the table GroupEntityMap (907 in FIG. 9) to each restricted column of the underlying database table or view, setting a table “r” column entry associated with a restricted column to “1” when no such group can be found, and otherwise to “0.”

With the columns for the security view created, in the first section of the create-view command 1102, the security view is populated with rows in the portion of the create-view command 1130. Another UDF is called, on lines 1132 and 1134, to determine whether or not there are any row restrictions for the user. When there are no row restrictions for the user, then all of the rows of the underlying database table or view are used to populate the view, in the selection statement of code section 1136. Otherwise, only those rows in which the row-restriction column has values equal to security-key values associated with the user, or with a group to which the user belongs, are selected in code section 1140. The UDF called on line 1142 returns all of the appropriate security keys for the column on which row security is defined that are personally provided to the user, or provided through one or more groups to the user. Finally, the “where” clause 1150 at the end of the create-table command causes return of an empty security view when a user belongs to no group that can access the table.

Thus, the security, view created for each table, as in the example create-view command shown in FIG. 11, is essentially a run-time filter that is automatically adapted, on each call, to provide access to rows and columns of a database or multiple databases for which a method or system embodiment of the present invention provides row-and-column-level access. The security view includes a UDF that identifies the calling user, whether the user access the security view directly through a database interface or indirectly through an application program, and other UDFs, that access the access-control database tables in order to identify rows of the underlying table or view to return to the user and columns values for the returned rows, based on row permissions and column restrictions associated directly with the user or with groups to which the user belongs.

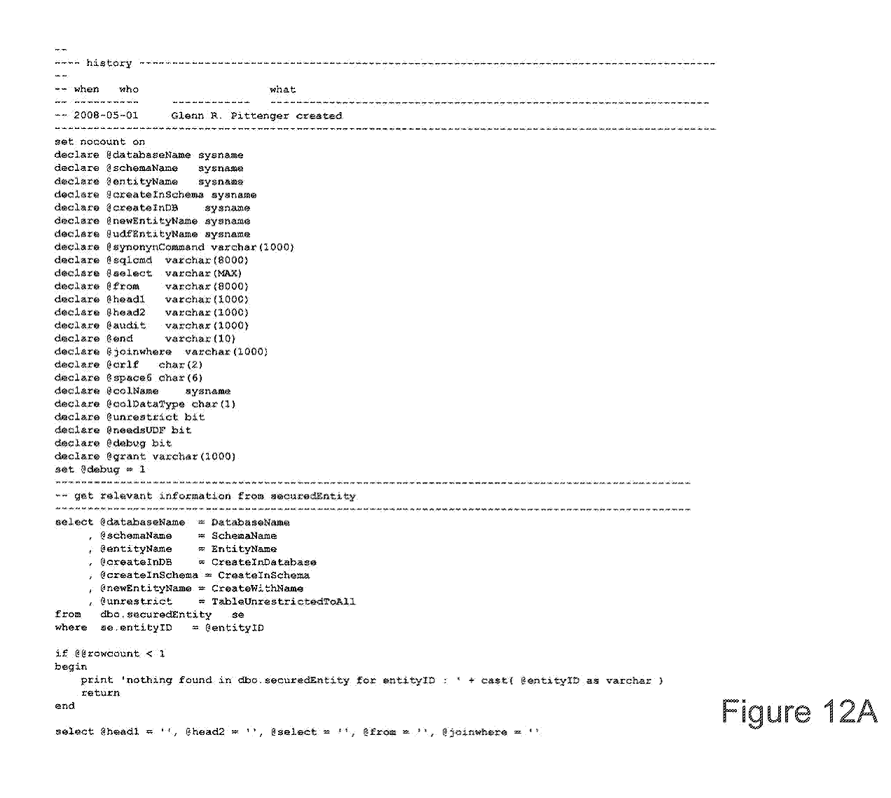

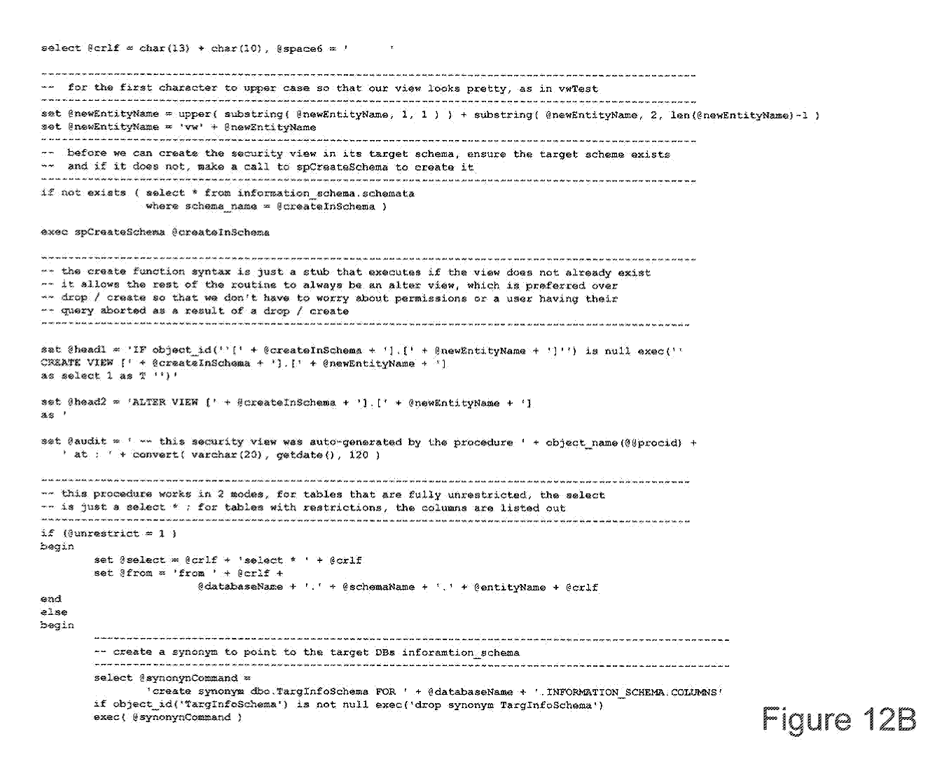

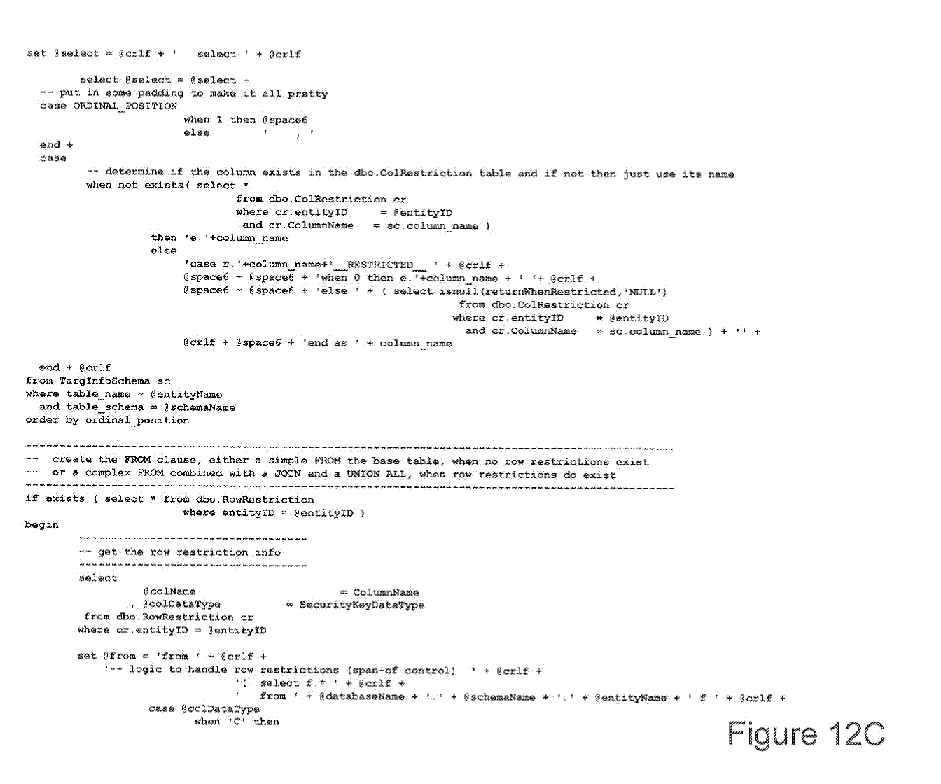

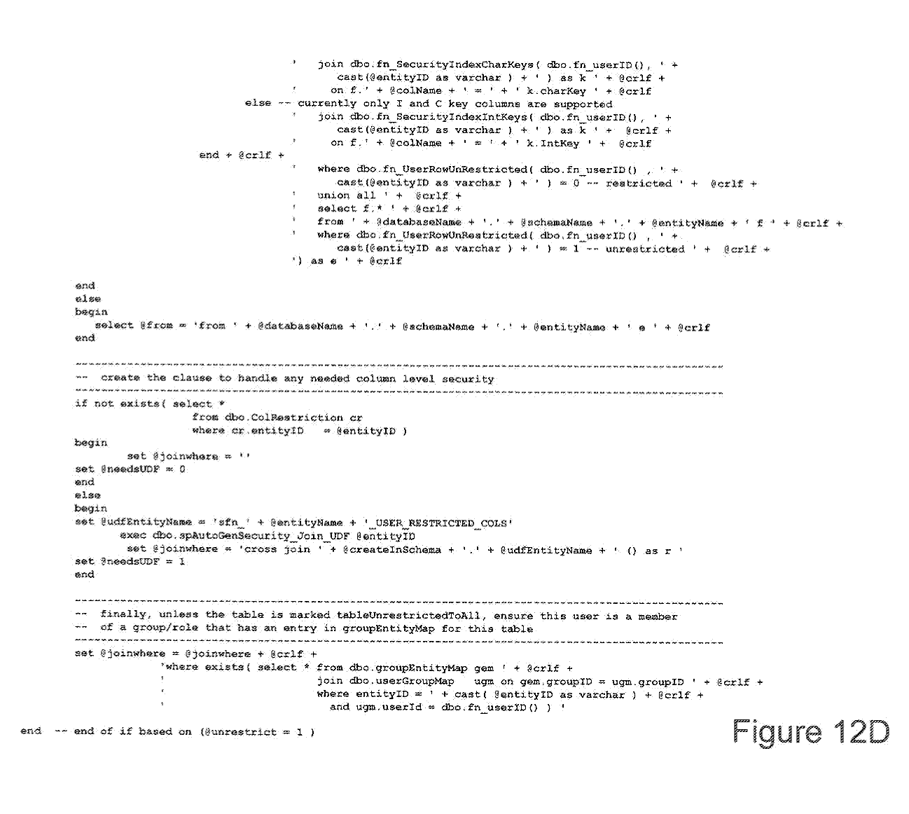

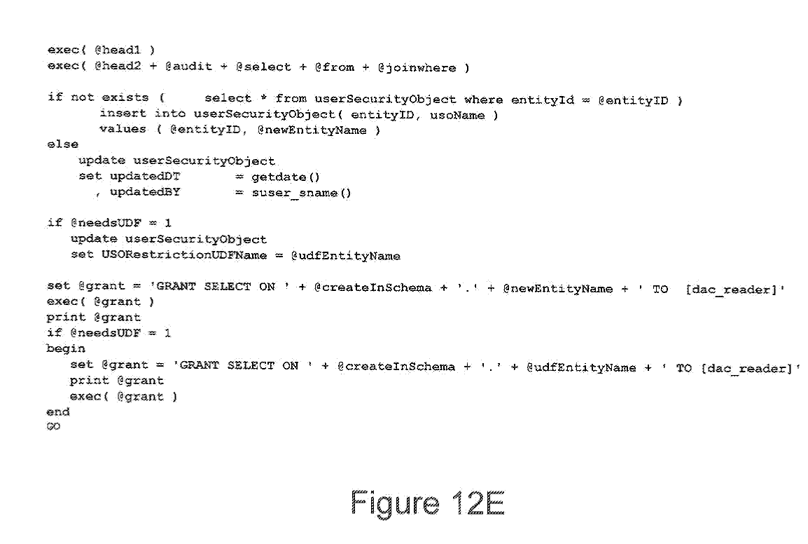

FIGS. 12A-E provide and exemplary auto-gen program. The autogen program builds a security view for each table and view of one or more databases to which row-and-column-level access control is applied by an embodiment of the present invention.

Advantages of the approaches employed in method and system embodiments of the present invention include run-time time and computation efficiencies, access-control-definition and access-control-application time efficiencies, and low administrative overheads for development and application. The access-control database comprises a modest number of relational tables created and managed by a DBMS, and the row-and-column-level access control is provided entirely automatically through DBMS-provided views and UDFs created through the DBMS interface. The computational efficiency can be increased by building indexes for security keys, to allow for more efficient access of row with values matching security-key values. The approaches employed in method and system embodiments of the present invention may, in many cases, outperform access-control features provided by DBMSs, and far outperform hypothetical access-control implementations based on creating views for each user through the DBMS interface.

Although the present invention has been described in terms of particular embodiments, it is not intended that the invention be limited to these embodiments. Modifications will be apparent to those skilled in the art. For example, in alternative embodiments of the present invention, row access may be defined with respect to multiple columns, rather than on a single column, as in the embodiment discussed above. Furthermore, in alternative embodiments, security keys may include range expressions for values of columns on which row access is defined, as well as UDFs that undertake more complex computations related to whether or not a row can be accessed by a user or group. Many additional, more complex column-restriction and row-permission computations may be performed in alternative embodiments, to provide for hierarchical nesting of permissions and restrictions for hierarchically related groups and subroups. In the present embodiment, when, columns are restricted to a user, the user sees only null, or other predefined values; in the column. In alternative embodiments of the present invention, a pair of security views may be created, one for database applications which need all of the columns to be represented in the security view, to avoid complex coding to handle unexpected column numbers in tables, and another security view may be created for direct access by users in which the restricted columns are omitted entirely, so that users have no way of knowing of the existence of those columns. Embodiments of the present invention can be created by using any of various different relational databases designed to execute on any of various different hardware platforms and operating systems, any of various query languages and data definition languages, in addition to standard SQL, and may use various different access-control databases, with greater or fewer tables than the access-control database illustrated in FIG. 9, and with data distributed among the tables differently than among the tables shown in FIG. 9.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An access-control system comprising:
an electronic access-control database; and
a security-view interface, including, a security view for each access-controlled table and view of an underlying electronic database, that is defined by data stored in the electronic access-control database and through which users of the underlying electronic database access the underlying database.

2. The access-control system of claim 1 wherein the electronic access-control database includes data entities that specify:
underlying tables and views to which access control is applied;
users for which access control is applied;
user groups;
column restrictions, each associated with a column of an underlying table or view;
row restrictions, each associated with a column of an underlying table or view;
row permissions, each associated with one or more users and/or groups, that provide access to restricted rows to the one or more users and/or groups; and
column restrictions, each associated with one or more user groups, that inhibit access to columns by members of the one or more groups.

3. The electronic access-control system of claim 1 wherein data included in the electronic access-control database is obtained through one or more of a user interface and structured data files input to a meta-data processing program.

4. The access-control system of claim 1 wherein an autogen program runs, at specified intervals, to create new security views for underlying tables and views for which new metadata has been added to the electronic access-control database since a last execution of the autogen program.

5. The access-control system of claim 1 wherein each security view comprises a relational database view implemented using user-defined functions.

6. The access-control system of claim 5 wherein, at run time, a first user-defined function determines a user identifier for a user accessing an underlying database entity through the security view.

7. The access-control system of claim 6 wherein, at run time, a second user-defined function determines, using metadata stored in the electronic access-control database, a first set of zero or more columns of the underlying database entity that are restricted to the user and a second set of zero or more columns of the underlying database entity that are accessible to the user.

8. The access-control system of claim 7 wherein an electronic-access-control-database-specified value is displayed or made accessible to the user in restricted columns and data of the underlying database entity are displayed or made accessible to the user for accessible column.

9. The access-control system of claim 7 wherein, at run time, a third user-defined function determines, using metadata stored in the electronic access-control database, those rows of the underlying database entity to include in the security view.

10. A method for providing access control to data entities, the method comprising:
creating an electronic access-control database;
storing access-control metadata in the electronic access-control database; and
using the access-control metadata in the electronic access-control database to create a security-view interface, including a security view for each access-controlled table and view of an underlying electronic database, through which users of the underlying electronic database access the underlying electronic database.

11. The method of claim 10 wherein the electronic access-control database includes data entities that specify:
underlying tables and views to which access control is applied;
users for which access control is applied;
user groups;
column restrictions, each associated with a column of an underlying table or view;
row restrictions, each associated with a column of an underlying table or view;
row permissions, each associated with one or more users and/or groups, that provide access to restricted rows to the one or more users and/or groups; and
column restrictions, each associated with one or more user groups, that inhibit access to columns by members of the one or more groups.

12. The method of claim 10 further including obtaining the data stored in the electronic access-control database through one or more of a user interface and structured data files input to a meta-data processing program.

13. The method of claim 10 further including executing an autogen program, at specified intervals, to create new security views for underlying tables and views for which new metadata has been added to the electronic access-control database since a last execution of the autogen program.

14. The method of claim 10 further comprising implementing each security view as a relational database view using user-defined functions.

15. The method of claim 14 further comprising using, at run time, a first user-defined function to determines a user identifier for a user accessing an underlying database entity through the security view.

16. The method of claim 15 further comprising using, at run time, a second user-defined function to determine, using metadata stored in the electronic access-control database, a first set of zero or more columns of the underlying database entity that are restricted to the user and a second set of zero or more columns of the underlying database entity that are accessible to the user.

17. The method of claim 16 further comprising displaying or making accessible an electronic-access-control-database-specified value to the user in restricted columns and displaying or making accessible to the user data of the underlying database entity for accessible column.

18. The method of claim 16 further comprising using, at run time, a third user-defined function to determines, using metadata stored in the electronic access-control database, those rows of the underlying database entity to include in the security view.
